(19) United States
(12) Patent Application Publication
(10) Pub. No.: US 2024/0272873 A1
(43) Pub. Date: Aug. 15, 2024

(54) METHOD FOR CALCULATING A TRANSITION FROM A BOOLEAN MASKING TO AN ARITHMETIC MASKING

(71) Applicant: GIESECKE+DEVRIENT EPAYMENTS GMBH, Munchen (DE)

(72) Inventor: Lars HOFFMANN, Munchen (DE)

(21) Appl. No.: 18/569,800

(22) PCT Filed: Jun. 23, 2022
(86) PCT No.: PCT/EP2022/025288

§ 371 Date: Dec. 13, 2023

(30) Foreign Application Priority Data
Jun. 24, 2021 (DE) 10 2021 003 275.6

(51) Int. Cl. G06F 7/76

(52) U.S. Cl. CPC G06F 7/764; G06F 2207/7233

(57) ABSTRACT

A method is provided for re-masking from a Boolean mask to an arithmetic mask with a modulus (2m*p), in which m is an integer greater than or equal to zero, and p has at least one prime divisor unequal to 2, so that a carry is generated. The carry is masked or balanced to protect it against intrusion attacks.

### FIELD OF THE INVENTION

The invention relates to the field of cryptography and, more specifically, to the field of protecting cryptographic calculations against unauthorized intrusion. In particular, the invention relates to the transition from a first masking of a value to be kept secret, which is based on a Boolean masking rule, to a second masking of the value to be kept secret, which is based on an arithmetic masking rule. The invention is particularly suitable for use in a resource-limited system, for example a chip card, such as a payment transaction card or a UICC (cellular SIM card) intended for operation in a cellular terminal, or a SIM chip module eUICC (embedded UICC) intended for permanent installation in a cellular terminal, or an integrated iUICC or Integrated SIM-chip module intended for integration into a chipset of a cellular terminal. The cellular terminal may be, for example, a smartphone or cell phone, or an Internet of Things device (IoT device), or an M2M device, in particular an industrial M2M device (with resource-restricted module: M2M(e)UICC module) or an automotive M2M telematics unit (with resource-limited module: M2M(e)UICC module).

### PRIOR ART

In SPA and DPA attacks (SPA=Simple Power Analysis, DPA=Differential Power Analysis) on cryptographic calculations, side-channel emissions from implementations of cryptographic calculations, such as power consumption or electromagnetic radiation from the chip on which the calculation is implemented, are evaluated in order to gain information about confidential data processed in the calculation. In order to defend against SPA and DPA attacks on cryptographic calculations, the confidential data which is processed in a cryptographic calculation is masked, i.e. disguised with a value called a mask, before any cryptographic calculations are performed.

Masking of a value to be kept secret can be based on different masking rules. The masking rule specifies the calculation rule by which the data to be protected is linked to the mask in order to obtain the masked representation of the data to be protected. Which masking rule is appropriate or most appropriate depends on the type of cryptographic calculation, as well as on the individual operations or partial calculations to be performed within the entirety of the cryptographic calculation.

Cases can occur in which, as part of the entirety of a cryptographic calculation, operations or partial calculations are executed consecutively in which different masking rules are more advantageous, or which are even only compatible with different masking rules. In such cases, it is desirable or necessary that a transition between two different masking rules be carried out within the entirety of the cryptographic calculation.

The prior art document WO 02/065692 A1 discloses a method for switching between a Boolean xor operation with a random number r as a first masking rule and a second, additive (arithmetic) masking rule, wherein, in order to implement the transition from the Boolean to the additive masking rule, a sequence of Boolean and arithmetic operations is performed.

The prior art document EP1596527 B1 discloses a method for an intrusion-resistant transition from a first masking of a secret value d to a second masking of the secret value d, wherein the secret value d: —exists in the first masking as a first representation ds masked with a first mask s according to a Boolean masking rule ds=d XOR s, and —in the second masking, exists as a second representation dr masked according to an arithmetic masking rule dr=(d+r) mod (2ⁿ) with a second mask r, where r is calculated such that ds=dr. More precisely, EP1596527 B1 discloses as a concrete embodiment of the invention a first masking d=d XOR z1 and a second masking d=d−z2 mod 2ⁿ. When switching from the first to the second mask, only the masking is changed, but not the calculation that is masked.

The document BSI-TR-03111 describes an implementation of the PACE protocol for authentication between a machine-readable document as a client and a terminal for reading out the chip of such a machine-readable travel document. In the PACE protocol, a shared secret K is first derived by means of a key derivation function KDF and, based on the shared secret K and a password, two symmetric keys are derived, namely an encryption key Kenc and an authentication key Kmac. The key derivation function KDF is, for example, a Diffie-Hellman (DH) or Elliptical Curve Diffie-Hellman (ECDH) key derivation method, into which asymmetric key pairs of the client and the terminal are entered. In the methods, calculations are carried out modulo a modulus which has at least one prime divisor unequal to two.

In the German patent application DE102020000814A1 by the applicant of the present application, an intrusion-resistant method for key generation is disclosed, configured in a client processor device, by means of which a second public client key P_{c}′ of the client is derived. In particular, the client is a machine-readable travel document. The method for key generation is in particular part of a PACE protocol or a comparable protocol for authentication between a machine-readable travel document as a client on the one hand, and a terminal for reading the chip of such a machine-readable travel document on the other. The PACE protocol authentication uses a second asymmetric key pair [k_{c}′, P_{c}′] of the client, comprising a second public client key P_{c}′ and a second private client key k_{c}′, wherein the first public client key P_{c}′ is formed as a result of an operation which takes the second private client key k_{c}′ and a generator point G on an elliptical curve and a nonce s as input. (In the conventional PACE protocol, the second public client key P_{c}′ is formed by dot multiplication P_{c}′=k_{c}·G′ of the second private client key k_{c}′ by the generator point G′ mapped onto the elliptical curve with a mapping function).

For the PACE protocol and the method for an improved PACE protocol disclosed in DE102020000814A1, it would also be desirable to have a method for switching from a Boolean masking to an arithmetic masking in order to consistently protect the secret parameters of the PACE protocol.

In particular, in protocols which are composed of symmetric and asymmetric cryptographic methods it can be advantageous to perform a change of mask from data modulo 2ⁿ to data modulo p, in which p has a prime divisor unequal to two. For these protocols, the specific examples given in EP1596527 B1 are not applicable.

The prior art document US2015/0172042A1 discloses a method for performing a masked modular addition in which a carry is processed in masked form.

The prior art document US2015/0110266A1 discloses a method comprising a conversion from an arithmetic masking to a Boolean masking, in which a masked carry is processed.

The prior art document DE102004052196A1 discloses a method for performing an operation on masked data in an intrusion-resistant manner, wherein a masked carry is also processed.

The prior art document DE102017002153A1 discloses a method for intrusion-resistant transition from a Boolean masking of a secret value to an additive masking.

The technical article by Goubin, L.: “A Sound Method for Switching between Boolean and Arithmetic Masking; CHES 2001, Lecture Notes in Computer Science, vol. 2162, Springer-Ver-lag, 2001, pp. 3-15, discloses a method for intrusion-resistant re-masking of a secret value from a Boolean masking to an arithmetic masking.

### SUMMARY OF THE INVENTION

The object of the invention is to provide a method for intrusion-resistant transition from a Boolean masking to an arithmetic masking using a modulus equal to or comprising p, where p has at least one prime divisor unequal to 2. In particular, the method specified is to be applicable to moduli p, where p is a prime number greater than two.

The object is achieved by a method according to any of the independent claims. In each of the independent claims, the common inventive concept realized is that of integrating a transition from a first modulus 2ⁿ to a second modulus p or comprising p into the transition from the first to the second masking. Advantageous embodiments of the invention are specified in the dependent claims.

The method as claimed in claim 1 is designed for intrusion-resistant re-masking of a value x to be kept secret from a first masking to a second masking, by carrying out a plurality of consecutive calculation steps. In this case, before the execution of the plurality of consecutive arithmetic steps, the value x to be kept secret exists in the first masking as a first representation xs masked with a first mask s according to a Boolean masking rule xs=x XOR s mod 2ⁿ, where 2ⁿ is the modulus of the first masking rule and n is an integer. After the execution of the plurality of consecutive arithmetic steps, the secret value x in the second masking exists as a second representation xr masked with a second mask r according to an arithmetic masking rule.

The method is characterized in that,
firstly:

$$xr = ( x + r ) mod ( {2}^{m} * p )$$

$$or xr = ( x - r ) mod ( {2}^{m} * p ) ,$$

where (2^{m}*p) is the modulus of the second masking rule and m is an integer greater than or equal to zero, where p has at least one prime divisor unequal to 2;
and secondly:
during the re-masking, at least one arithmetic calculation step is carried out in which a carry c1 is generated over 2ⁿ, the carry c1 being protected against intrusion by masking or balancing the carry c1 by means of a random information item pm, and in a subsequent calculation step in which the carry c1 is intended for use the masked carry C_pm or the balanced carry C is used instead of the carry.

In the methods described in EP1596527 B1, the carries arising in the calculations are not relevant to the result of the masking change. This is not the case in a transition to a masking rule modulo (2^{m}*p), where p has at least one prime divisor unequal to 2. The occurring carries therefore provide an opportunity for intrusion attacks, which does not exist with a modulus of 2ⁿ.

According to the invention, the carry c1 is protected against intrusion attacks. The protection of the carry is accomplished either by masking the carry c1 or balancing the carry c1, followed by subsequent calculation with the masked or balanced carry c1, but not with the carry c1, which exists as plain text. This means that the possibility of attack on the calculation formed by the calculation steps, which is opened up by the non-power-of-2 modulus, is closed again.

The modulus (2^{m}*p) of the second masking rule is equal to p in the special case m=0, and also in the special case of a prime number unequal to 2. In the more general case, for other values of m, for example m=1, 2, 3, 4, 5, . . . , the modulus contains a product of a power of two and an integer p which has at least one prime divisor unequal to 2.

Therefore, according to claim 1, a method is provided for intrusion-resistant transition from a Boolean masking to an arithmetic masking using a modulus equal to or comprising p, where p has at least one prime divisor unequal to 2.

In embodiments of the method according to the invention with masking of the carry c1, the carry c1 is optionally masked by means of the random information pm, by processing the carry c1 by means of an XOR operation with the random information pm into c1pm=c1 XOR pm, and c1pm is used as the masked carry C_pm, or the masked carry C_pm for the subsequent steps is derived from c1pm.

In embodiments of the method according to the invention with balancing of the carry c1, the carry c1 is optionally balanced by means of random information pm, by representing the secret value x in the second masking as either xr=(x+r) mod (2ⁿ*p) or xr=(x−r) mod (2ⁿ*p), selected at random under the control of the random information pm, wherein the balanced carry c1 is used as the carry C or the carry C can be derived from the balanced carry c1. This ensures that the frequency of the different values of the carry C for all possible values of r and pm is independent of x.

In embodiments of the method according to the invention with masking or/and balancing of the carry c1, the carry C_pm or C is optionally additively masked by means of a random number z_p, 0<=z_p<p and then reduced, thereby generating an intermediate result sum1zp_p. Subsequently, sum1zp_p is combined with other intermediate results, for example as described in the following detailed exemplary embodiments.

The method according to the invention is particularly useful in key derivation methods in which two parties each derive a shared secret individually, for example Diffie-Hellman (DH) or Elliptical Curve Diffie-Hellman (ECDH), or similar methods, for example ECIES or the like.

The method is particularly useful in machine-readable travel documents, such as passports with a chip (integrated circuit) and an interface, for example an antenna, and for reading such machine-readable travel documents with readers designed for such machine-readable travel documents. The readers have a reader circuit and an interface which is or can be coupled to the reader circuit for communication with machine-readable travel documents.

In particular, the method is useful in the PACE protocol for reading machine-readable travel documents by means of a reader for machine-readable travel documents.

Key derivation methods according to the invention, machine-readable travel documents and readers are configured for methods according to the invention.

### DETAILED DESCRIPTION OF THE EXEMPLARY EMBODIMENTS

In detail, the protection of the carry c1 is achieved in particular optionally with the following embodiments of the method according to the invention.

### 1. Balancing I

The second mask r is calculated iteratively for a balanced procedure according to a procedure comprising the following steps:
calculating MAX_p=2ⁿ mod p and
MAX_p2=2ⁿ+2*p−MAX_p once only;
selecting a random number z1, 0<=z1<2ⁿ, selecting a random number z_p, 0<=z_p<p;
selecting a random bit pm to balance the carry c1, the value of which is randomly controlled as either 0 or 1;
performing the following steps:

| | |
|---|---|
| 1. | sz1 = z1 XOR s |
| 2. | xz1 = xs XOR sz1 |
| 3. | xsz1 = xs XOR z1 |
| 4. | If pm == 0: |
| | a. add1 = sz1 + 2ⁿ |
| | b. sub1c= add1 − z1 |
| | else: |
| | a. add1 = z1 + 2ⁿ |
| | b. sub1c= add1 − sz1 |
| 5. | c1 = sub1c >> n |
| 6. | sub1 = sub1c mod 2ⁿ |
| 7. | add2 = xsz1 + 2ⁿ 8. sub2c = add2 − xz1 |
| 9. | c2 = sub2c >> n |
| 10. | sub2 = subc2 mod 2ⁿ |
| 11. | xor1 = sub1 XOR s |
| 12. | r_low = xor1 XOR sub2 |
| 13. | C = c1 XOR c2 |
| 14. | sum1 = (p − C*MAX_p) |
| 15. | sum1zp = sum1 + z_p |
| 16. | sum1zp_p = sum1zp mod p |
| 17. | p_z_p = p − z_p |
| 18. | sum2 = r_low + sum1zp_p |
| 19. | p_sum2 = MAX_p2 − sum2 |
| 20. | If pm == 0: |
| | a. xr = xs + z_p |
| | b. r = sum2 |
| | else: |
| | a. xr = xs + p_z_p |
| | b. r = p_sum2. |

### 2. Balancing II.

The second mask r is calculated iteratively for a balanced procedure according to a procedure comprising the following steps:
calculating MAX_p=2ⁿ mod p and
MAX_p2=2ⁿ+2*p−MAX_p once only;
selecting a random number z1, 0<=z1<2ⁿ, selecting a random number z_p, 0<=z_p<p;
selecting a random bit pm, the value of which is randomly controlled as either 0 or 1;
performing the following steps:

| | |
|---|---|
| 1. | sz1 = z1 XOR s |
| 2. | xz1 = xs XOR sz1 |
| 3. | xsz1 = xs XOR z1 |
| 4. | If pm == 0: |
| | a. add1 = xz1 + 2ⁿ |
| | b. sub1c= add1 − sz1 |
| | else: |
| | a. add1 = sz1 + 2ⁿ |
| | b. sub1c= add1 − xz1 |
| 5. | c1 = sub1c >> n |
| 6. | sub1 = sub1c mod 2ⁿ |
| 7. | add2 = xsz1 + 2ⁿ |
| 8. | sub2c = add2 − z1 |
| 9. | c2 = sub2c >> n |
| 10. | sub2 = subc2 mod 2ⁿ |
| 11. | xor1 = sub1 XOR xs |
| 12. | xr_low = xor1 XOR sub2 |
| 13. | C = c1 XOR c2 |
| 14. | sum1 = (p − C*MAX_p) |
| 15. | sum1zp = sum1 + z_p |
| 16. | sum1zp_p = sum1zp mod p |
| 17. | p_z_p = p − z_p |
| 18. | sum2 = xr_low + sum1zp_p |
| 19. | p_sum2 = MAX_p2 − sum2 |
| 20. | If pm == 0: |
| | a. r = s + p_z_p |
| | b. xr = sum2 |
| | else: |
| | a. r = s + z_p |
| | b. xr = p_sum2. |

### 3. Masking I

The second mask r is calculated iteratively according to a procedure that includes the following steps:
calculating MAX_p=2ⁿ mod p and
MAX_p2=2ⁿ+2*p−MAX_p once only;
selecting a random number z1, 0<=z1<2ⁿ, selecting a random number z_p, 0<=z_p<p;
selecting a random bit pm, the value of which is randomly controlled as either 0 or 1;
performing the following steps, comprising a step of masking the carry c1, 14.c1pm=c1 XOR pm:

| | |
|---|---|
| 1. | sz1 = z1 XOR s |
| 2. | xz1 = xs XOR sz1 |
| 3. | xsz1 = xs XOR z1 |
| 4. | add1 = sz1 + 2ⁿ |
| 5. | sub1c = add1 − z1 |
| 6. | c1 = sub1c >> n |
| 7. | sub1 = sub1c mod 2ⁿ |
| 8. | add2 = xsz1 + 2ⁿ |
| 9. | sub2c = add2 − xz1 |
| 10. | c2 = sub2c >> n |
| 11. | sub2 = subc2 mod 2ⁿ |
| 12. | xor1 = sub1 XOR s |
| 13. | r_low = xor1 XOR sub2 |
| 14. | c1pm = c1 XOR pm |
| 15. | C_pm = c1pm XOR c2 |
| 16. | sum1 = (p − C_pm*MAX_p) |
| 17. | sum1zp = sum1 + z_p |
| 18. | sum1zp_p = sum1zp mod p |
| 19. | p_ sum1zp_p = p − sum1zp_p |
| 20. | p_z_p = p − z_p |
| 21. | r_low_p = r_low + p |
| 22. | sum2 = r_low_p − pm * MAX_p |
| 23. | If pm == 0: |
| | a. xr = xs + Z_p |
| | b. r = sum2 + sum1zp_p |
| | else: |
| | a. xr = xs + p_z_p |
| | b. r = sum2 + p_sum1zp_p . |

### 4. Masking II

The second mask r is calculated iteratively according to a procedure that includes the following steps:
calculating MAX_p=2ⁿ mod p and
MAX_p2=2ⁿ+2*p−MAX_p once only;
selecting a random number z1, 0<=z1<2ⁿ, selecting a random number z_p, 0<=z_p<p;
selecting a random bit pm, the value of which is randomly controlled as either 0 or 1;
performing the following steps, comprising a step of masking the carry c1, 14.c1 pm=c1 XOR pm:

| | |
|---|---|
| 1. | sz1 = z1 XOR s |
| 2. | xz1 = xs XOR sz1 |
| 3. | xsz1 = xs XOR z1 |
| 4. | add1 = xsz1 + 2ⁿ |
| 5. | sub1c = add1 − sz1 |
| 6. | c1 = sub1c >> n |
| 7. | sub1 = sub1c mod 2ⁿ |
| 8. | add2 = xsz1 + 2ⁿ |
| 9. | sub2c = add2 − z1 |
| 10 | c2 = sub2c >> n |
| 11. | sub2 = subc2 mod 2ⁿ |
| 12. | xor1 = sub1 XOR xs |
| 13. | xr_low = xor1 XOR sub2 |
| 14 | c1pm = c1 XOR pm |
| 15. | C_pm = c1pm XOR c2 |
| 16 | sum1 = (p − C_pm*MAX_p) |
| 17. | sum1zp = sum1 + z_p |
| 18 | sum1zp_p = sum1zp mod p |
| 19. | p_ sum1zp_p = p − sum1zp_p |
| 20 | p_z_p = p − z_p |
| 21. | xr_low_p = xr_low + p |
| 22. | sum2 = xr_low_p − pm * MAX_p |
| 23. | If pm == 0: |
| | a. r = s + p_z_p |
| | b. xr = sum2 + sum1zp_p |
| | else: |
| | a. r = s + z_p |
| | b. xr = sum2 + p_sum1zp_p . |

In all embodiments of the method, an optional additional step of modular reduction of the masked value xr and the mask r can be carried out, wherein the additional step 21 follows step 20, or the additional step 24 follows step 23, according to:

$$a . xr\_p = xr mod p$$

$$b . r\_p = r mod p .$$

### BRIEF DESCRIPTION OF THE DRAWINGS

In the following the invention is explained in further detail based on exemplary embodiments and by reference to the drawings, in which:

FIG. 1 shows a system for illustrating the invention.

### DETAILED DESCRIPTION OF THE EXEMPLARY EMBODIMENTS

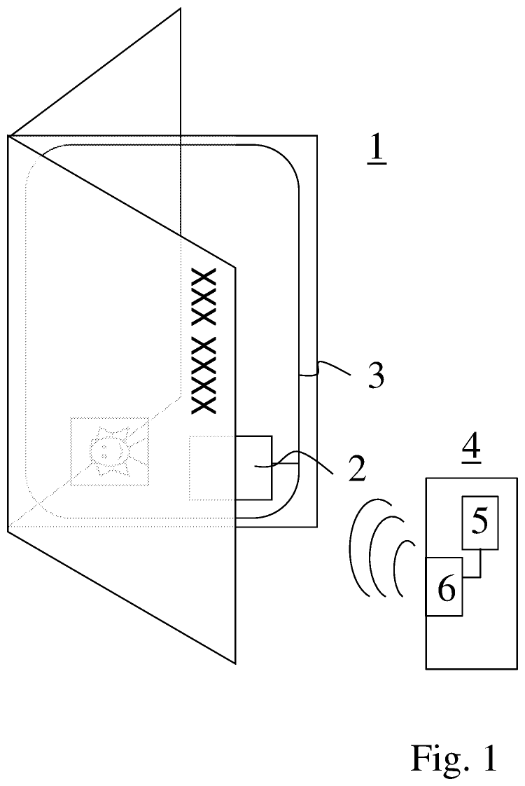

FIG. 1 shows a machine-readable travel document 1 with an integrated circuit 2 and an interface designed as an antenna 3, which is or can be connected to the integrated circuit 2. The integrated circuit 2 is configured for the PACE protocol. The PACE protocol comprises a key derivation method in which the method according to the invention is integrated. The machine-readable travel document 1 can be read out with a suitably configured reader 4, which has a reader circuit 5 and an interface 6, e.g. a corresponding antenna. Such readers 4 for machine-readable travel documents such as the machine-readable travel document 1 are arranged, for example, at control stations such as airports or border crossings.

1.-12. (canceled)

13. A method for intrusion-resistant re-masking of a value x to be kept secret from a first masking to a second masking, by carrying out a plurality of successive calculation steps, wherein the secret value x:
exists in the first masking, before the execution of the plurality of calculation arithmetic steps, as a first representation xs masked with a first mask s according to a Boolean masking rule xs=x XOR s mod 2n, where 2n is the modulus of the first masking rule, where n is an integer, and
in the second masking, after the execution of the plurality of consecutive calculation steps, exists as a second representation xr masked according to an arithmetic masking rule with a second mask r,
wherein:
xr=(x+r) mod (2m*p) or xr=(x−r) mod (2m*p), where (2m*p) is the modulus of the second masking rule and m is an integer greater than or equal to zero, where p has at least one prime divisor unequal to 2; and
during the re-masking, at least one arithmetic calculation step is carried out, in which a carry c1 is generated over 2n, the carry c1 being protected against intrusion attacks by masking or balancing the carry c1 by means of a random information item pm, and in a subsequent calculation step in which the carry c1 is intended for use, the masked carry C_pm or the balanced car-ry C is used instead of the carry.

14. The method according to claim 13, wherein the carry c1 is masked by means of the random information pm, by processing the carry c1 by means of an XOR operation with the random information pm to c1 pm=c1 XOR pm, and c1pm is used as the masked carry C_pm, or the masked carry C_pm is derived from c1pm.

15. The method according to claim 13, wherein the carry c1 is balanced by means of random information pm, by representing the secret value x in the second masking as either xr=(x+r) mod (2n*p) or xr=(x−r) mod (2n*p), selected at random under the control of the random information pm, where-in the balanced carry c1 is used as the carry C or the carry C can be derived from the balanced carry c1.

16. The method according to claim 14, wherein the carry C_pm or C by means of a random number z_p, 0<=z_p<p, is additively masked and then reduced,
wherein an intermediate result sum1zp_p is generated, and wherein in subsequent steps further calculations use the intermediate result sum1zp_p instead of the carry C_pm or C.

17. The method according to claim 16, in conjunction with 3, wherein the second mask r is iteratively calculated according to a procedure comprising the following steps:
calculating MAX_p=2n mod p and
MAX_p2=2n+2*p−MAX_p once only;
selecting a random number z1, 0<=z1<2n, selecting a random number z_p, 0<=z_p<p;
selecting a random bit pm, the value of which is randomly controlled as either 0 or 1;
performing the following steps:

| 1. | sz1 = z1 XOR s |
|---|---|
| 2. | xz1 = xs XOR sz1 |
| 3. | xsz1 = xs XOR z1 |
| 4. | If pm == 0: |
| a. add1 = sz1 + 2n | |
| b. sub1c= add1 − z1 | |
| else: | |
| a. add1 = z1 + 2n | |
| b. sub1c= add1 − sz1 | |
| 5. | c1 = sub1c >> n |
| 6. | sub1 = sub1c mod 2n |
| 7. | add2 = xsz1 + 2n |
| 8. | sub2c = add2 − xz1 |
| 9. | c2 = sub2c >> n |
| 10. | sub2 = subc2 mod 2n |
| 11. | xor1 = sub1 XOR s |
| 12. | r_low = xor1 XOR sub2 |
| 13. | C = c1 XOR c2 |
| 14. | sum1 = (p − C*MAX_p) |
| 15. | sum1zp = sum1 + z_p |
| 16. | sum1zp_p = sum1zp mod p |
| 17. | p_z_p = p − z_p |
| 18. | sum2 = r_low + sum1zp_p |
| 19. | p_sum2 = MAX_p2 − sum2 |
| 20. | If pm == 0: |

a. xr = xs + z_p
b. r = sum2
else:
a. xr = xs + p_z_p
b. r = p_sum2.

18. The method according to claim 16, in conjunction with 3, wherein the second mask r is iteratively calculated according to a procedure comprising the following steps:
calculating MAX_p=2n mod p and
MAX_p2=2n+2*p−MAX_p once only;
selecting a random number z1, 0<=z1<2n, selecting a random number z_p, 0<=z_p<p;
selecting a random bit pm, the value of which is randomly controlled as either 0 or 1;
performing the following steps:

| 1. | sz1 = z1 XOR s |
|---|---|
| 2. | xz1 = xs XOR sz1 |
| 3. | xsz1 = xs XOR z1 |
| 4. | If pm == 0: |
| a. add1 = xz1 + 2n | |
| b. sub1c= add1 − sz1 | |
| | else: |
| a. add1 = sz1 + 2n | |
| b. sub1c= add1 − xz1 | |
| 5. | c1 = sub1c >> n |
| 6. | sub1 = sub1c mod 2n |
| 7. | add2 = xsz1 + 2n |
| 8. | sub2c = add2 − z1 |
| 9. | c2 = sub2c >> n |
| 10. | sub2 = subc2 mod 2n |
| 11. | xor1 = sub1 XOR xs |
| 12. | xr_low = xor1 XOR sub2 |
| 13. | C = c1 XOR c2 |
| 14. | sum1 =(p − C*MAX_p) |
| 15. | sum1zp = sum1 + z_p |
| 16. | sum1zp_p = sum1zp mod p |
| 17. | p_z_p = p − z_p |
| 18. | sum2 = xr_low + sum1zp_p |
| 19. | p_sum2 = MAX_p2 − sum2 |
| 20. | If pm == 0: |

a. r = s + p_z_p
b. xr = sum2
else:
a. r = s + z_p
b. xr = p_sum2.

19. The method according to claim 16, in conjunction with 2, wherein the second mask r is iteratively calculated according to a procedure comprising the following steps:
calculating MAX_p=2n mod p and
MAX_p2=2n+2*p−MAX_p once only;
selecting a random number z1, 0<=z1<2n, selecting a random number z_p, 0<=z_p<p;
selecting a random bit pm, the value of which is randomly controlled as either 0 or 1;
performing the following steps, comprising a step of masking the carry c1, 14.c1pm=c1 XOR pm:

| 1. | sz1 = z1 XOR s |
|---|---|
| 2. | xz1 = xs XOR sz1 |
| 3. | xsz1 = xs XOR z1 |
| 4. | add1 = sz1 + 2n |
| 5. | sub1c = add1 − z1 |
| 6. | c1 = sub1c >> n |
| 7. | sub1 = sub1c mod 2n |
| 8. | add2 = xsz1 + 2n |
| 9. | sub2c = add2 − xz1 |
| 10. | c2 = sub2c >> n |
| 11. | sub2 = subc2 mod 2n |
| 12. | xor1 = sub1 XOR s |
| 13. | r_low = xor1 XOR sub2 |
| 14. | c1pm = c1 XOR pm |
| 15. | C_pm = c1pm XOR c2 |
| 16. | sum 1 = (p − C_pm*MAX_p) |
| 17. | sum1zp = sum1 + z_p |
| 18. | sum1zp_p = sum1zp mod p |
| 19. | p_ sum1zp_p = p − sum1zp_p |
| 20. | p_z_p = p − z_p |
| 21. | r_low_p = r_low + p |
| 22. | sum2 = r_low_p − pm * MAX_p |
| 23. | If pm == 0: |
| a. | xr = xs + z_p |
| b. | r = sum2 + sum1zp_p |
| else: | |
| a. | xr = xs + p_z_p |
| b. | r = sum2 + p_sum1zp_p . |

20. The method according to claim 16, in conjunction with 2, wherein the second mask r is iteratively calculated according to a procedure comprising the following steps:
calculating MAX_p=2n mod p and
MAX_p2=2n+2+p−MAX_p once only;
selecting a random number z1, 0<=z1<2n, selecting a random number z_p, 0<=z_p<p;
selecting a random bit pm, the value of which is randomly controlled as either 0 or 1;
performing the following steps, comprising a step of masking the carry c1, 14.c1pm=c1 XOR pm:

| 1. | sz1 = z1 XOR s |
|---|---|
| 2. | xz1 = xs XOR sz1 |
| 3. | xsz1 = xs XOR z1 |
| 4. | add1 = xsz1 + 2n |
| 5. | sub1c = add1 − sz1 |
| 6. | c1 = sub1c >> n |
| 7. | sub1 = sub1c mod 2n |
| 8. | add2 = xsz1 + 2n |
| 9. | sub2c = add2 − z1 |
| 10. | c2 = sub2c >> n |
| 11. | sub2 = subc2 mod 2n |
| 12. | xor1 = sub1 XOR xs |
| 13. | xr_low = xor1 XOR sub2 |
| 14. | c1pm = c1 XOR pm |
| 15. | C_pm = c1pm XOR c2 |
| 16. | sum1 = (p − C_pm*MAX_p) |
| 17. | sum1zp = sum1 + z_p |
| 18. | sum1zp_p = sum1zp mod p |
| 19. | p_ sum1zp_p = p − sum1zp_p |
| 20. | p_z_p = p − z_p |
| 21. | xr_low_p = xr_low + p |
| 22. | sum2 = xr_low_p − pm * MAX_p |
| 23. | If pm == 0: |
| a. | r = s + p_z_p |
| b. | xr = sum2 + sum1zp_p |
| else: | |
| a. | r = s + z_p |
| b. | xr = sum2 + p_sum1zp_p . |

21. The method according to claim 17, comprising the further step 21, or step 24, of performing a modular reduction of the masked value xr and the mask r according to
$$a . xr\_p = xr mod p$$
$$b . r\_p = r mod p .$$

22. A key-derivation method, designed as a DH or ECDH key-derivation method or similar key-derivation method, comprising a method according to claim 13.

23. A machine-readable travel document comprising an integrated circuit, which is configured for a key-derivation method according to claim 22, and an interface for communication with a reader.

24. A reader comprising a reader circuit and an interface for communication with a machine-readable travel document and configured for reading a machine-readable travel document according to claim 23.
